(19) United States
(12) Patent Application Publication
(10) Pub. No.: US 2008/0161221 A1
(43) Pub. Date: Jul. 3, 2008

(54) AZEOTROPIC SOLVENT COMPOSITION AND MIXED SOLVENT COMPOSITION

(75) Inventors: Hidekazu OKAMOTO, Chiyoda-ku (JP); Masaaki Tsuzaki, Chiyoda-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY, LIMITED, Chiyoda-ku (JP)

(21) Appl. No.: 12/045,092

(22) Filed: Mar. 10, 2008

Related U.S. Application Data
(63) Continuation of application No. PCT/JP2006/317138, filed on Aug. 30, 2006.

(30) Foreign Application Priority Data
Sep. 13, 2005 (JP) 2005-264668

(51) Int. Cl. C11D 17/00

(52) U.S. Cl. 510/411

(57) ABSTRACT

To provide a new uninflammable solvent composition which is capable of removing soils such as oils attached to electronic components such as ICs, precision machine components or glass substrates, or flux and dusts attached on e.g. printed boards.

A mixed solvent composition comprising from 40 to 90 mass % of 1,1,2,2,3,3,4,4,5,5,6,6-tridecafluorooctane and from 10 to 60 mass % of isopropanol, and an azeotropic solvent composition comprising 62 mass % of 1,1,1,2,2,3,3,4,4,5,5,6,6-tridecafluorooctane and 38 mass % of isopropanol.

### TECHNICAL FIELD

The present invention relates to a solvent composition which is used for removing soils such as oils attached to electronic components such as ICs, precision machinery components or articles such as glass substrates, or flux and dusts attached on printed boards, particularly such soils containing ionic components.

### BACKGROUND ART

Heretofore, in the precision machinery industry, the optical instrument industry, the electrical and electronics industry and the plastics processing industry, for precision cleaning to remove e.g. oils, flux, dusts and waxes attached during manufacturing processes etc., a hydrochlorofluorocarbon (hereinafter referred to as HCFC) such as dichloropentafluoropropane (hereinafter referred to as R-225) has been widely used as a fluorinated solvent which is uninflammable and has excellent chemical and thermal stability, and which has high solvency for oils.

However, since HCFCs have ozone depleting potentials, their production will be abolished in 2020 in industrialized countries. Various studies have been made for a substitute solvent for HCFCs. For example, an azeotropic mixture of 1,1,2,2-tetrafluoro-1-(2,2,2-trifluoroethoxy)ethane and ethanol has been proposed (Patent Document 1). However, this azeotropic mixture has about 6% of an azeotropic composition of ethanol, and it is insufficient for cleaning ionic compounds. On the other hand, a water-removing composition comprising a fluorinated aliphatic hydrocarbon such as octafluorobutane and a lower alcohol such as ethanol has been proposed (Patent Document 2). However, such a composition is not a composition having an azeotropic point and the volatilization rates of mixed components are different, whereby the liquid composition changes during its use or storage.

Further, a mixed solvent comprising 1,1,1,2,2,3,3,4,4-nonafluorohexane (hereinafter referred to as HFC-569sf) and 2-propanol has been proposed as a solvent to be used for degreasing/cleaning or flux cleaning (Patent Document 3). However, this composition had a problem that the performance to remove soils containing ionic components, was poor.

Patent Document 1: JP-A-4-227695

Patent Document 2: JP-A-5-154302

Patent Document 3: JP-A-7-62394

### DISCLOSURE OF THE INVENTION

### Object of the Invention

The object of the present invention is to provide a solvent composition having zero ozone depleting potential and an enough solvency to remove oils, flux, dusts, waxes, etc.

### Means to Accomplish the Object

The present invention provides an azeotropic solvent composition comprising 62 mass % of 1,1,1,2,2,3,3,4,4,5,5,6,6-tridecafluorooctane and 38 mass % of isopropanol.

Further, the present invention provides a mixed solvent composition comprising from 40 to 90 mass % of 1,1,1,2,2,3,3,4,4,5,5,6,6-tridecafluorooctane and from 10 to 60 mass % of isopropanol.

### EFFECTS OF THE INVENTION

The solvent composition of the present invention shows excellent cleaning performance to remove oils and flux. Particularly, the azeotropic solvent composition or the mixed solvent composition close to an azeotropic composition, of the present invention, undergoes no or little change in composition even if it is used repeatedly by recycling it to steam cleaning and distillation. Thus, it may be used as it is for a cleaning device which used to employ a solvent consisting of one component. That is, no substantial modification of the cleaning device is required.

### BRIEF DESCRIPTION OF THE DRAWING

FIG. 1 is a graph showing the results of gas-liquid equilibrium measurements in Example 1.

### BEST MODE FOR CARRYING OUT THE INVENTION

The azeotropic solvent composition of the present invention comprises 1,1,1,2,2,3,3,4,4,5,5,6,6-tridecafluorooctane and isopropanol. The boiling point of this azeotropic composition is 79.5° C. at a pressure of 1010 hPa. This azeotropic solvent composition shows an enough solvency when it is used as a cleaning agent to remove oils and flux. On the other hand, in general, an azeotropic composition undergoes no change in composition when it is repeatedly vaporized and condensed, and therefore, there is an advantage such that a vaporized solvent composition is easily recovered and recycled. The azeotropic solvent composition of the present invention also has this advantage.

The mixed solvent composition of the present invention contains 1,1,1,2,2,3,3,4,4,5,5,6,6-tridecafluorooctane in an amount of from 40 to 90 mass %, preferably from 50 to 70 mass %. When the content of 1,1,1,2,2,3,3,4,4,5,5,6,6-tridecafluorooctane is in the above range, the composition becomes a hardly flammable composition.

The mixed solvent composition of the present invention contains isopropanol in an amount of from 10 to 60 mass %, preferably from 30 to 50 mass %. When the content of isopropanol is in the above range, the composition shows an excellent solvency to remove oils and flux.

The mixed solvent composition of the present invention preferably consists of 1,1,1,2,2,3,3,4,4,5,5,6,6-tridecafluorooctane and isopropanol only. In such a case, the mixed solvent composition is a hardly flammable composition, and has an excellent solvency to remove oils. It also has an enough cleaning power to remove an ionic substance such as flux.

Further, when the mixed solvent composition of the present invention consists of the two components only, the composition is preferably an azeotrope-like composition. The azeotrope-like composition is a composition which undergoes a relatively small change in composition when it is repeatedly vaporized and condensed.

In such a case, as the change in composition is small when it is repeatedly vaporized and condensed, just like the azeotropic solvent composition, there is an advantage such that a vaporized solvent composition is easily recovered and recycled.

The mixed solvent composition of the present invention preferably consists of 1,1,1,2,2,3,3,4,4,5,5,6,6-tridecafluorooctane and isopropanol only, but other compounds may be further contained as the case requires. The content of the other compounds in the mixed solvent composition is preferably below 20 mass %, particularly preferably below 10 mass %.

As such other compounds, at least one compound selected from the group consisting of hydrocarbons, alcohols (other than isopropanol), ketones, halogenated hydrocarbons (other than 1,1,1,2,2,3,3,4,4,5,5,6,6-tridecafluorooctane), ethers and esters, may be mentioned.

As the hydrocarbons, C₅₋₁₅ linear or cyclic, saturated or unsaturated hydrocarbons are preferred, and n-pentane, 2-methylbutane, n-hexane, 2-methylpentane, 2,2-dimethylbutane, 2,3-dimethylbutane, n-heptane, 2-methylhexane, 3-methylhexane, 2,4-dimethylpentane, n-octane, 2-methylheptane, 3-methylheptane, 4-methylheptane, 2,2-dimethylhexane, 2,5-dimethylhexane, 3,3-dimethylhexane, 2-methyl-3-ethylpentane, 3-methyl-3-ethylpentane, 2,3,3-trimethylpentane, 2,3,4-trimethylpentane, 2,2,3-trimethylpentane, 2-methylheptane, 2,2,4-trimethylpentane, n-nonane, 2,2,5-trimethylhexane, n-decane, n-dodecane, cyclopentane, methylcyclopentane, cyclohexane, methylcyclohexane, ethylcyclohexane or bicyclohexane may, for example, be mentioned. More preferred is a C₅₋₇ hydrocarbon such as n-pentane, cyclopentane, n-hexane, cyclohexane or n-heptane.

As the alcohols, C₁₋₁₆ linear or cyclic alcohols are preferred, and methanol, ethanol, n-propanol, n-butanol, sec-butanol, isobutanol, tert-butanol, 1-pentanol, 2-pentanol, 1-ethyl-1-propanol, 2-methyl-1-butanol, 3-methyl-1-butanol, 3-methyl-2-butanol, neopentyl alcohol, 1-hexanol, 2-methyl-1-pentanol, 4-methyl-2-pentanol, 2-ethyl-1-butanol, 1-heptanol, 2-heptanol, 3-heptanol, 1-octanol, 2-octanol, 2-ethyl-1-hexanol, 1-nonanol, 3,5,5-trimethyl-1-hexanol, 1-decanol, 1-undecanol, 1-dodecanol, cyclohexanol, 1-methylcyclohexanol, 2-methylcyclohexanol, 3-methylcyclohexanol, 4-methylcyclohexanol, α-terpineol, 2,6-dimethyl-4-heptanol, nonyl alcohol or tetradecyl alcohol may, for example, be mentioned. More preferred is an alkanol having below three carbon atoms such as methanol or ethanol.

As the ketones, C₃₋₉ linear or cyclic ketones are preferred, and specifically, acetone, methyl ethyl ketone 2-pentanone, 3-pentanone, 2-hexanone, methyl isobutyl ketone, 2-heptanone, 3-heptanone, 4-heptanone, diisobutyl ketone, cyclohexanone, methyl cyclohexanone or acetophenone may, for example, be mentioned. More preferred is a C₃₋₄ ketone such as acetone or methyl ethyl ketone.

As the halogenated hydrocarbons, C₁₋₆ saturated or unsaturated, chlorinated or chlorofluorinated hydrocarbons are preferred, and methylene chloride, 1,1-dichloroethane, 1,2-dichloroethane, 1,1,2-trichloroethane, 1,1,1,2-tetrachloroethane, 1,1,2,2,tetrachloroethane, pentachloroethane, 1,1-dichloroethylene, cis-1,2-dichloroethylene, trans-1,2-dichloroethylene, trichloroethylene, tetrachloroethylene, 1,2-dichloropropane, dichloropentafluoropropane, dichlorofluoroethane or decafluoropentane may, for example, be mentioned. More preferred is a compound having an unsaturated bond such as trichloroethylene or tetrachloroethylene which has a small ozone depleting potential.

As the ethers, C₂₋₈ linear or cyclic ethers are preferred, and diethyl ether, dipropyl ether, diisopropyl ether, dibutyl ether, ethyl vinyl ether, butyl vinyl ether, anisole, phenetole, methyl anisole, dioxane, furan, methyl furan or tetrahydrofuran may, for example, be mentioned. More preferred is a C₄₋₆ ether such as diethyl ether, diisopropyl ether, dioxane or tetrahydrofuran.

As the esters, C₂₋₁₉ linear or cyclic esters are preferred, and specifically, methyl acetate, ethyl acetate, propyl acetate, isopropyl acetate, butyl acetate, isobutyl acetate, sec-butyl acetate, pentyl acetate, methoxybutyl acetate, sec-hexyl acetate, 2-ethylbutyl acetate, 2-ethylhexyl acetate, cyclohexyl acetate, benzyl acetate, methyl propionate, ethyl propionate, butyl propionate, ethyl 2-hydroxy-2-methyl propionate, diethyl phthalate or dibutyl phthalate may, for example, be mentioned. More preferred is a C₃₋₄ ester such as methyl acetate or ethyl acetate.

Further, primarily in order to increase the stability, one or more of the following exemplified compounds may be contained in the mixed solvent composition of the present invention in a range of from 0.001 to 5 mass %.

A nitro compound such as nitromethane, nitroethane, nitropropane or nitrobenzene; an amine such as diethylamine, triethylamine, isopropylamine or n-butylamine; a phenol such as phenol, o-cresol, m-cresol, p-cresol, thymol, p-t-butylphenol, t-butylcatechol, catechol, isoeugenol, o-methoxyphenol, bisphenol A, isoamyl salicylate, benzyl salicylate, methyl salicylate or 2,6-di-t-butyl-p-cresol; and a triazole such as 2-(2′-hydroxy-5′-methylphenyl)benzotriazole, 2-(2′-hydroxy-3′-t-butyl-5′-methylphenyl)-5-chlorobenzotriazole, 1,2,3-benzotriazole or 1-[(N,N-bis-2-ethylhexyl)aminomethyl]benzotriazole.

The azeotropic solvent composition and the mixed solvent composition of the present invention may be suitably used for various purposes, like the conventional dichloropentafluoropropane composition. The specific purposes may, for example, be a cleaning agent to remove soils attached to articles, a coating solvent or an extraction agent for various compounds. The material for the above articles may, for example, be glass, ceramics, plastic, elastomer or metal. Further, the specific examples of the articles may be electrical and electronic instruments, precision machines-apparatus or optical instruments, and their components such as ICs, micromotors, relays, bearings, optical lenses, printed boards or glass substrates. The soils attached to the articles may, for example, be soils which are residues of materials used for producing articles or components constituting the articles, and which need to be eventually removed; or soils attached during use of the articles. Materials to form soils may, for example, be greases, mineral oils, waxes, oil-based inks, flux or dusts.

The specific method to remove the above soils may, for example, be hand wiping, dip cleaning, spray cleaning, oscillation cleaning, ultrasonic cleaning or vapor cleaning. It is possible to use such methods in combination.

In the solvent composition of the present invention, by changing the blend ratio of the components constituting the composition, it is possible to adjust the power to dissolve soils, etc.

### EXAMPLES

Now, the present invention will be described in further detail with reference to Examples. Examples 1, 2 to 4, 6 to 8, 10 and 11 represent the present invention, and Examples 5, 9 and 12 represent Comparative Examples.

### Example 1

The gas-liquid equilibrium and the azeotropic point of 1,1,1,2,2,3,3,4,4,5,5,6,6-tridecafluorooctane (CF₃CF₂CF₂CF₂CF₂CF₂CH₂CH₃, hereinafter referred to as HFC-76-13sf) and isopropanol ((CH₃)₂CHOH, hereinafter referred to as IPA) were measured by using an Othmer vapor-liquid equilibrium apparatus (manufactured by SIBATA SCIENTIFIC TECHNOLOGY LTD).

HFC-76-13sf and IPA were put in a sample container with a various compositional ratio, and then heating was started. Heating was adjusted to have a proper dropping speed of a gas-phase condensate liquid, and a stable boiling state was kept for 2 hours. The stabilities of the pressure and boiling point were ascertained, and then, liquids of the liquid phase side and the gas phase side were analyzed by gas chromatography to measure the compositional ratio of HFC-76-13sf in the respective phases (liquid phase, gas phase).

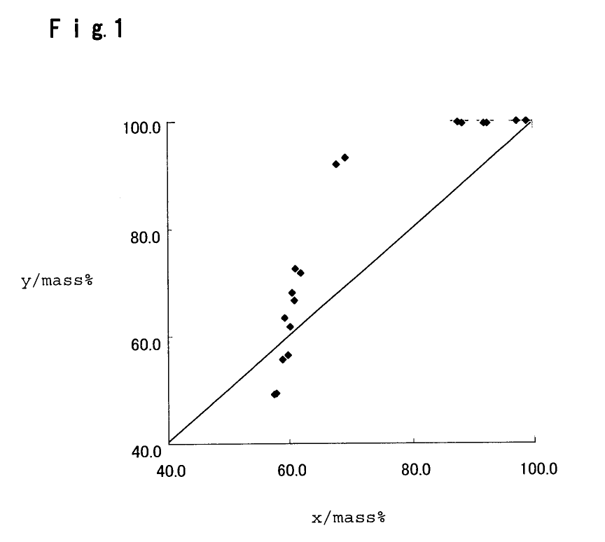

The results of the measurements (compositional ratios of HFC-76-13sf after boiling for two hours) are shown in Table 1 and FIG. 1.

TABLE 1

| Liquid phase | Gas phase |
|---|---|
| HFC-76-13sf | HFC-76-13sf |
| Compositional | Compositional |
| ratio x (mass %) | ratio y (mass %) |
| 99.9 | 97.3 |
| 99.9 | 98.9 |
| 99.7 | 92.5 |
| 99.6 | 91.9 |
| 99.8 | 87.7 |
| 99.6 | 88.4 |
| 93.3 | 69.3 |
| 92.1 | 67.8 |
| 71.8 | 61.8 |
| 72.7 | 60.9 |
| 66.7 | 60.8 |
| 68.1 | 60.5 |
| 61.8 | 60.1 |
| 63.6 | 59.3 |
| 62.0 | 62.0 |
| 49.2 | 57.4 |
| 49.4 | 57.9 |
| 56.6 | 59.7 |
| 55.7 | 58.8 |

### Examples 2 to 5

A cleaning test to remove metalworking fluid was carried out by using a solvent composition having the composition as identified in Table 2. That is, a SUS-304 test piece (25 mm×30 mm×2 mm) was immersed in the metalworking fluid: Temper Oil (manufactured by NIPPON GREASE CO., LTD) to have the metalworking fluid attached thereto. After the test piece was taken out from the metalworking fluid, it was immersed for 5 minutes in the solvent composition which was kept at 40° C., and then it was cleaned for 5 minutes by applying ultrasonic waves. The removal degree of the metal working fluid was evaluated by visual observation. The results are shown in Table 2. In the Table, ◯: well removed, Δ: residue slightly remained, X: residue substantially remained.

TABLE 2

| Example | HFC-76-13sf | IPA | Evaluation |
|---|---|---|---|
| 2 | 40 mass % | 60 mass % | ◯ |
| 3 | 62 mass % | 38 mass % | ◯ |
| 4 | 90 mass % | 10 mass % | ◯ |
| 5 | 100 mass % | 0 mass % | Δ |

### Examples 6 to 9

A flux cleaning test was carried out by using a solvent composition having the composition as identified in Table 3. That is, flux JS-64ND manufactured by KOKI Company Ltd., was applied to an IPC B-25 comb electrode substrate and dried for 10 minutes at 100° C., and then, it was immersed in a solder bath of 260° C. for 3 seconds for soldering. Then, after being left to stand for 2 hours at room temperature, the comb electrode substrate was immersed in the solvent composition as identified in Table 3, which was kept at 40° C., and then it was cleaned for 5 minutes by applying ultrasonic waves. The removal degree of flux was evaluated by visual observation. The results are shown in Table 4. In the Table, ◯: well removed, Δ: residue slightly remained, X: residue substantially remained.

TABLE 3

| Example | HFC-76-13sf | IPA | Evaluation |
|---|---|---|---|
| 6 | 40 mass % | 60 mass % | ◯ |
| 7 | 62 mass % | 38 mass % | ◯ |
| 8 | 90 mass % | 10 mass % | ◯ |
| 9 | 100 mass % | 0 mass % | X |

### Example 10

The solvent composition identified in Table 4 was put in a triple tank cleaning machine, which was operated for 8 hours. Then, the solvent in a water-separation tank was measured by gas chromatography. Among the results of the measurement, the compositional ratio of HFC-76-13sf was as shown in Table 4.

TABLE 4

| | |
|---|---|
| | compositional |
| Solvent composition | ratio of HFC-76- |
| before operation of | 13sf after |
| cleaning machine | operation for 8 |

| Example | HFC-76-13sf | IPA | hours |
|---|---|---|---|
| 10 | 62 mass % | 38 mass % | 62 mass % |

### Examples 11 and 12

A 100 mesh stainless-steel woven metal wire was immersed in water-soluble Press Oil G-2710 (manufactured by NIHON KOHSAKUYU CO., LTD). After it was pulled out, it was kept at 110° C. for one hour to obtain an object to be cleaned, and it was cleaned by using the solvent composition as identified in Table 5.

The cleaning was carried out by a method such that the object to be cleaned was immersed in the solvent composition at 40° C. for 1 minute, and then it was immersed in the solvent composition at room temperature (about 27° C.) for 1 minute. Finally, it was exposed to the vapor of the solvent composition for 1 minute. After the cleaning, Omega Meter 600SMD (Alpha Metals Japan LTD.) was used to measure the amount of the ionic component remained on the object after cleaning, within 15 minutes of measuring time. Further, the amount of the ionic component on the object before cleaning, was 730 μg (calculated as NaCl).

The results of measuring the composition of the solvent composition used and the ionic amount after cleaning, are shown in Table 5.

TABLE 5

| | | Amount of |
|---|---|---|
| | | ionic |
| | | component μg |
| | Cleaning solvent | (calculated |
| Example | composition (mass %) | as NaCl) |
| 11 | HFC-76-13sf/IPA = 62/38 | 127 |
| 12 | HFC-569sf/IPA = 90.3/9.7 | 244 |

### INDUSTRIAL APPLICABILITY

The composition of the present invention is useful to remove soils such as oils attached to electronic components such as ICs, precision machine components or articles such as glass substrates, or flux and dusts attached on printed boards.

The entire disclosure of Japanese Patent Application No. 2005-264668 filed on Sep. 13, 2005 including specification, claims, drawings and summary is incorporated herein by reference in its entirety.

What is claimed is:

1. An azeotropic solvent composition comprising 62 mass % of 1,1,1,2,2,3,3,4,4,5,5,6,6-tridecafluorooctane and 38 mass % of isopropanol.

2. A mixed solvent composition comprising from 40 to 90 mass % of 1,1,1,2,2,3,3,4,4,5,5,6,6-tridecafluorooctane and from 10 to 60 mass % of isopropanol.

3. The mixed solvent composition according to claim 2, which further contains at most 20 mass % of at least one compound selected from the group consisting of a hydrocarbon, an alcohol (other than isopropanol), a ketone, a halogenated hydrocarbon (other than 1,1,1,2,2,3,3,4,4,5,5,6,6-tridecafluorooctane), an ether and an ester.

4. A method of cleaning an article to be cleaned, which comprises bringing the solvent composition as defined in claim 1 into contact with the article having oil attached, to remove the oil from the article.

5. A method of cleaning an article to be cleaned, which comprises bringing the solvent composition as defined in claim 1 into contact with the article having flux attached, to remove the flux from the article.

6. The method of cleaning an article to be cleaned according to claim 4, wherein the oil attached to the above article contains an ionic component.

7. The method of cleaning an article to be cleaned according to claim 5, wherein the flux attached to the above article contains an ionic component.
